(19) United States
(12) Patent Application Publication
(10) Pub. No.: US 2026/0003175 A1
(43) Pub. Date: Jan. 1, 2026

(54) Microscope, slide reader and microscopy method

(71) Applicant: Carl Zeiss Microscopy GmbH, Jena (DE)

(72) Inventors: Tiemo Anhut, Jena (DE); Daniel Schwedt, Jena (DE)

(21) Appl. No.: 19/252,767

(22) Filed: Jun. 27, 2025

(30) Foreign Application Priority Data
Jun. 29, 2024 (DE) 10 2024 118 478.7

(51) Int. Cl. G02B 21/00; G01N 21/64

(52) U.S. Cl. CPC G02B 21/0076; G01N 21/6458; G02B 21/0032; G01N 2201/0638; G01N 2201/0675; G01N 2201/0683; G01N 2201/105

(57) ABSTRACT

A microscope having a light source for transmitting excitation light, an illumination beam path for guiding the excitation light into a sample region and for modifying a polarization state of the excitation light, a phase plate for creating an illumination pattern, a cylindrical optics unit for creating an elongate distribution of the excitation light, a scanning unit for scanning the elongate distribution of the excitation light through the sample region, a camera for recording images, a detection beam path with a microscope objective for guiding emission light onto the camera and a control unit for controlling the scanning unit and/or the camera and for reading out measurement data from the camera. The camera is arranged in a non-descanned part of the detection beam path and the control unit is configured to synchronize a location of a slot-shaped readout region in a sensor plane of the camera with a location of the elongate distribution of the excitation light in a plane of the sample.

The current application claims the benefit of German Patent Application No. 10 2024 118 478.7, filed on 29 Jun. 2024, which is hereby incorporated by reference.

The invention relates to a microscope according to the preamble of claim 1, to a slide reader and to a microscopy method according to the preamble of claim 28.

A generic microscope is disclosed in [SHEN] and comprises the following constituent parts: a light source for transmitting excitation light; an illumination beam path for guiding the excitation light into a sample region, wherein the illumination beam path comprises a controllable polarization manipulator for modifying a polarization state of the excitation light, a phase plate for creating an illumination pattern, a cylindrical optics unit for creating an elongate distribution of the excitation light, a scanning unit for at least one-dimensionally scanning the elongate distribution of the excitation light through the sample region and an illumination objective for guiding the excitation light into the sample region; a camera for recording images of a sample in the sample region; a detection beam path with a microscope objective for guiding emission light, which was radiated by the sample, onto the camera; and a control unit for controlling the scanning unit and/or the camera and for reading out measurement data from the camera.

At least the following method steps are performed in a generic microscopy method, which is also described in [SHEN]: a sample region is illuminated using excitation light, a polarization state of the excitation light is set, an illumination pattern that depends on the polarization state of the excitation light is created, an elongate distribution of the excitation light is created, the elongate distribution of the excitation light is guided via an illumination objective into the sample region and scanned through the sample region, emission light radiated by a sample in the sample region is guided to a camera using a microscope objective and images of the sample are recorded using the camera.

Fluorescence imaging of three-dimensional microscopic objects is of great value in many fields of biological and medical research and routine.

Such imaging must meet a number of requirements which, to date, have been difficult to meet simultaneously. For example, the expectation is that the resolution should be diffraction-limited or better, while structures outside of the focal plane are efficiently suppressed. Furthermore, such methods should not damage the samples or should damage them as little as possible, with this risk generally existing in particular in the case of light intensities that are too high and/or light doses that are too large. Moreover, these methods should enable imaging that is as fast as possible, either in order to be able to track very fast processes (e.g. blood flow, Ca waves, voltages) or in order to be able to be used in automated systems.

Line-scanning systems already solve some of the above-described problems: As a result of a quite high degree of parallelization in comparison with point-scanning laser microscopes, measurements can be performed quickly on the one hand and in sample-sparing fashion on the other. In comparison with other parallel systems, for example spinning disk systems which have been established for a long time, line-scanning systems may be significantly more flexible, e.g. because it is possible to match the (semi-) confocal slot width to the utilized objective. The slot referred to here corresponds to a pinhole in point-scanning microscopy. Like this pinhole, this slot is situated in a conjugate plane to the object plane or in the focal plane of the utilized objective. This slot serves to suppress out-of-focus light. However, a problem with line-scanning systems is that the suppression of the out-of-focus signal is not as good as in the case of point-scanning microscopes.

At this point in time, interest in three-dimensional cell cultures, such as spheroids and organoids, is increasing. These should be imaged microscopically in fast and sparing fashion. The microscope disclosed in WO2023117236A1 is suitable to this end. However, the above-described effect of the out-of-focus background is particularly bothersome in WO2023117236A1.

The semi-confocal mode of operation of the described system already leads to suppression of out-of-focus light. In the case of optically thick samples, for example spheroids or organoids, this suppression and the contrast of said thick samples is not yet sufficient. In this context, there is a need for methods and arrangements that are able to improve on the line-scanning methods.

Moreover, the invention is based on various pieces of previous work known from the literature. In [PANT], the method of focal modulation microscopy (FMM) is presented on the basis of a line-scanning microscope. It is already known that FMM may also be used in point-scanning methods. For example, this was described in [CHEN], DE102011013613A1 and DE201210010207A1. The fact that the type of modulating filter has an influencing on the imaging was already identified during the application of the point-scanning methods, [GAO]. Recently, the fact that this also applies to FMM methods that are based on a line scan approach was shown in [SHEN].

The microscope explained in this document is similar to the arrangement described in DE102023005252.3. Here, the arrangement from DE102023005252.3 is modified and developed substantially in order to achieve improved discrimination of stray light.

A problem addressed by the invention may be considered that of specifying a microscope, a slide reader and a microscopy method that allow the quick examination of three-dimensional samples with a good suppression of background light.

This problem is solved by the microscope having the features of claim 1, by the slide reader having the features of claim 27 and by the method having the features of claim 28.

According to the invention, the microscope of the aforementioned type is developed in that the camera is arranged in a non-descanned part of the detection beam path and in that the control unit is configured to synchronize a location of a slot-shaped readout region in a sensor plane of the camera with a location of the elongate distribution of the excitation light in a plane of the sample.

According to the invention, the method of the aforementioned type is developed in that the emission light is guided onto the camera in non-descanned fashion and in that a location of a slot-shaped readout region in a sensor plane of the camera is synchronized with a location of the elongate distribution of the excitation light in a plane of the sample.

The slide reader according to the invention comprises a microscope according to the invention.

The microscope according to the invention may be configured in particular to perform the method according to the invention. The methods according to the invention may be performed in particular using the microscope according to the invention. Advantageous exemplary embodiments of the microscope according to the invention and preferred variants of the method according to the invention are described below, in particular with reference to the dependent claims and the figures.

The excitation light, which may also be referred to as illumination light, is electromagnetic radiation, preferably in the visible range and adjacent ranges. In essence, lasers are conceivable as a light source for the invention, but other light sources, for example LED light sources, are also possible. In advantageous variants of the invention, linear or nonlinear states that lead to the emission of photons are excited in a sample by way of the excitation light. This means that expediently use is made of light sources that are capable of exciting the desired states in the sample linearly or nonlinearly. For example, dye molecules used to prepare the samples to be examined are excited to transmit fluorescence by a 1-photon process or a multiphoton process, for example a 2-photon process. In typical exemplary embodiments, the microscope is a fluorescence microscope, and the method is a fluorescence microscopy method. The microscope may be an upright or an inverted microscope. The light source may comprise a laser and preferably be a laser module having a plurality of lasers.

A feature whereby the control unit is configured to synchronize respective readout regions on a sensor surface of the camera with a position of the excitation light in a sample region as defined by the scanning unit is understood to mean that the control unit is configured to control the camera and/or the scanning unit in such a way that the desired synchronization is achieved. It is consequently possible that the control unit controls the camera, and the camera in turn controls the scanning unit or is coupled to the latter. It is also possible that the control unit controls the scanning unit, and the scanning unit controls the camera or is coupled to the latter. Which components of camera or control unit are “masters” or “slaves” during the control is consequently unimportant. For example, scanning curves for controlling the scanner may be stored in a memory, and the camera parameters determine the scanning curve that needs to be traversed. Moreover, the camera may trigger this process.

With regard to the samples to be examined, there is no restriction, in principle. However, the invention may be used particularly advantageously in the examination of biological samples, in particular also living samples. Microfluidic chips may also be used.

By preference, the light source supplies linearly polarized light. Should this not be the case, a polarizer for creating linearly polarized excitation light may be arranged in the illumination beam path between the light source and the polarization manipulator.

The term illumination beam path denotes all optical beam-guiding and beam-modifying components, for example an illumination objective, a microscope objective, lenses, mirrors, prisms, gratings, filters, stops, beam splitters, modulators, e.g. spatial light modulators (SLM), by means of which and via which the excitation light from the light source is guided to the sample to be examined. Beam-modifying components may also comprise dispersive and in particular diffractive elements. Commercially available microscope objectives may be used, in principle.

A spatial region on the object side of the illumination objective, in which a sample may be arranged, for example in a sample holder that is mounted on an xy-displacement stage, is also referred to as sample region within this description. In this sense, the terms sample and sample region are used synonymously.

Within the scope of the present application, the term polarization state of the excitation light in essence refers to the direction of a linear polarization of the excitation light.

The phase plate is a segmented optical component, with the individual segments having different effects on the phase angle of the excitation light depending on the polarization state of the incoming excitation light. In other words, the excitation light experiences a distinct phase shift depending on which segment of the phase plate it traverses. Since the respective segments of the phase plate are located at laterally different—or equivalently: transversely different—locations relative to the optical axis (should the optical axis for example extend in the z-direction in the case of a Cartesian xyz-coordinate system, the various segments may each cover different regions in the xy-plane, for example), it is also possible to say that the phase plate brings about a transversely variable phase shift.

The term cylindrical optics unit denotes an optical component or an optical assembly having a plurality of optical components that modifies, typically focuses, incident light differently in the two directions that are perpendicular to each other and to the optical axis. A typical example is given by a cylindrical lens that focuses incident light in only one of the two lateral directions while transmitting it substantially unchanged in the perpendicular direction. A substantially linear or elongate distribution of the excitation light, which is created by a cylindrical optics unit, is also referred to as an illumination line or line focus. The cylindrical optics unit may also be an anamorphic optics unit or comprise anamorphic components. The cylindrical optics unit may also comprise special optical elements, such as Powell lenses.

The scanning unit serves to move the elongate distribution of the excitation light, which is provided by the cylindrical optics unit, through the sample or the sample region in a direction transversely to the direction of extent of the illumination line, and thus linearly scan the sample. For example, the scanning unit comprises a scanner. Since scanning need only be performed in one direction, it may be sufficient for the scanner to be capable of one-dimensional scanning. For example, an illumination line extending in the x-direction is scanned in the y-direction perpendicular thereto. Advantageously, the scanning unit and/or the scanner is arranged in a pupil plane or in the vicinity of a pupil plane of the illumination beam path.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the respective components, for example SLMs, each have a finite extent in the direction of the optical axis.

In advantageous variants, the scanning unit and/or a further scanning unit present in the detection beam path—this will be described below—comprises at least one galvanometric scanner or a MEMS scanner or is formed by one of these components.

The term detection beam path denotes all beam-guiding and beam-modifying optical components, for example objectives, lenses, mirrors, prisms, gratings, filters, stops, beam splitters, modulators, e.g. spatial light modulators (SLMs), by means of which and via which the detection light is guided from the sample to be examined to the camera. The illumination objective of the illumination beam path and the microscope objective of the detection beam path may advantageously be one and the same microscope objective. That may be the case for reflected-light microscopy, for example, in which the sample is illuminated and observed from one and the same direction. In principle, however, it is also possible that the detection beam path has a separate microscope objective. The microscope objective may be an objective that is at least partially corrected in view of aberrations.

The emission light is electromagnetic radiation that is radiated by the sample as a consequence of being illuminated with excitation light. Radiating means that the emission light comes from the sample. The emission light may also be referred to as detection light. The emission light may be reflected back off the sample or may be light that is transmitted through the illuminated sample. In comparison with the excitation light, the emission light may typically be red-shifted fluorescence from fluorescent markers used to prepare the sample.

The camera is a two-dimensionally spatially resolving detector and may be a CCD, CMOS or SPAD array camera, for example. In the invention, the camera is located in the non-descanned beam path.

Expediently, the camera may be arranged in the detection beam path in such a way that the sensor surface of the camera is perpendicular to the optical axis of the detection beam path and that, moreover, the pixel lines of the camera lie parallel to a direction of extent of elongate regions of the emission light that can be traced back in each case to elongate regions of the illumination of the sample.

The term control unit denotes all hardware and software components which interact with the components of the microscope according to the invention for the intended function thereof. In particular, the control unit may comprise a computing device, for example a PC, and a camera controller. The computer resources of the control unit may be distributed among a plurality of computers and optionally a computer network, in particular also via the Internet. The controller may have in particular customary operating equipment and peripherals, such as mouse, keyboard, screen, storage media, joystick, Internet connection. The controller may in particular read the image data from the camera and may also be configured and serve to control the light source, typically for the purpose of setting a wavelength.

The microscope objective may be arranged on a microscope stand. The microscope stand may comprise an objective turret, in particular a controllable objective turret, having a plurality of microscope objectives. The control unit may be configured to control the objective turret having a plurality of microscope objectives.

In order to laterally vary a position of the sample relative to the microscope objective, a controllable xy-displacement stage on which the sample can be arranged may be present, especially as part of a microscope stand, and the control unit may be configured to control the xy-displacement stage. In order to vary an axial distance of the sample from the microscope objective, a z-drive may be present, especially as part of the microscope stand. The control unit may be configured to control the z-drive.

The non-descanned part of the detection beam path refers to a part of the detection beam path in which the beam of propagating emission light, especially in an intermediate image plane or in the vicinity of an intermediate image plane, moves synchronously with the illuminated sample space object plane location that is varied by the scanning unit in the illumination beam path.

The feature whereby a location of slot-shaped readout regions in a sensor plane of the camera is synchronized with the location of the elongate distribution of the excitation light in a plane of the sample is understood to mean that the sensor pixels of the camera that are read out at any given time are precisely those that are located in the sensor plane of the camera in a region that is optically conjugate to a region in an object plane in the sample region that is impinged with an illumination pattern of the excitation light at the relevant time.

The functionality of reading out a defined number of lines, with the readout region moving across the camera chip during an image recording, is referred to as “rolling shutter” and is a camera property. For example, a “rolling shutter” allows defined regions of the camera sensor to be read out, in particular only these regions that run over the camera sensor. Optionally, this functionality must be implemented for a specific camera sensor.

The invention is based on the insight that the use of a rolling shutter camera is particularly well suited to the microscopy technique described herein and opens up additional possibilities in comparison with the prior art.

It may be considered to be a substantial advantage of the present invention that fast high-resolution three-dimensional microscopy with comparatively little impact on the sample is possible using a simple, compact and in particular flexible arrangement. Moreover, it is possible to realize an effective suppression of out-of-focus light that in terms of its capability goes beyond what can be achieved using only a semi-confocal stop, especially in the case of optically thick samples.

In preferred configurations, the phase plate comprises a stripe-like arrangement of in each case at least one first region and at least one second region, wherein the at least one first region is formed by a birefringent material and the at least one second region is formed by a non-birefringent material. Advantageously, the first regions and the second regions may be stripe-shaped regions in each case. The first regions and the second regions may in each case be arranged in alternation, i.e., with the exception of edge regions, each first region has two second regions as neighbors, and vice versa. The first regions and the second regions may advantageously be aligned parallel to one another and perpendicular to the optical axis in each case. The phase plate may be a plane parallel plate that is arranged in the illumination beam path perpendicular to the optical axis. By preference, the first regions and second regions may each constitute an equal fraction of the total area of the phase plate.

The phase plate may have an even number of first regions. In this case, the stripe-like arrangement may be anti-symmetrical in relation to a reflection with respect to an axis extending centrally parallel to the direction of extent of the stripes. However, it is also possible for the phase plate to have an odd number of first regions. In this case, the stripe-like arrangement may in particular be mirror-symmetrical with respect to the axis extending centrally parallel to the direction of extent of the stripes. In both cases, the phase plate may thus have axial symmetry with respect to an axis extending parallel to the direction of extent of the strips.

The properties of the phase plate determine the possible illumination patterns to be generated in a manner dependent on the polarization direction of the incoming excitation light. The spatial structures suitable for the method of a line-scanning focal modulation microscope, and consequently suitable phase plates, were already described in detail in [SHEN]. The control unit is preferably configured to control the polarization manipulator in such a way that the polarization direction of the excitation light emerging from the polarization manipulator is oriented either perpendicular or parallel to an axis of the phase plate. For example, the axis of the phase plate may be the axis extending centrally parallel to the direction of extent of the stripes.

For applications in which the illumination pattern should be switched over after each complete recording of an image, and consequently should be switched over comparatively slowly, it may be sufficient for the polarization manipulator to comprise a controllable liquid-crystal manipulator or be formed thereby.

For applications in which the illumination pattern should be switched over more quickly, for example after each recording of image data for a single line-shaped region, it is preferable for the polarization manipulator to comprise a controllable electro-optic manipulator or be formed thereby.

To set a beam diameter of the excitation light, the illumination beam path may advantageously comprise a settable telescope optics unit and/or a zoom optics unit upstream of the polarization manipulator. The phase plate and the polarization manipulator are preferably situated in a collimated part of the illumination beam path. Optionally, an optical device, for example a lens, for collimating the excitation light may be present in the illumination beam path upstream of the phase plate, upstream of the telescope optics unit and/or upstream of the zoom optics unit.

Expediently, the cylindrical optics unit may comprise at least one cylindrical lens for the purpose of creating elongate illumination patterns.

A settable stop for setting a numerical aperture of the cylindrical optics unit may be present upstream of the cylindrical optics unit in the illumination beam path. This settable stop may serve to set a width, for example of an illumination line, in a pupil plane.

In an alternative to that or in addition, the cylindrical optics unit may comprise at least one further cylindrical lens that is optionally introducible into the beam path and that serves to reduce a length of the linear focal region in its direction of extent in a pupil plane. A reduction in the length of the linear focal region in the pupil plane leads to a focal region with a greater axial extent in the sample region and hence to a larger region that may be scanned using a controllable optics unit with variable refractive power that is optionally present in the detection beam path. In an alternative to that or in addition, the illumination beam path may comprise a settable stop for setting a length of elongate illumination regions in their direction of extent, in particular in a pupil plane.

In a particularly preferred configuration, a first illumination pattern in an intermediate image plane comprises at least one central elongate illumination region which comprises a local or absolute maximum of the illumination intensity. For example, such a shape of the illumination pattern may be achieved if the polarization direction is set relative to the phase plate in such a way that the first regions and the second regions each cause the same phase shift in the traversing excitation light.

A second illumination pattern may advantageously in an intermediate image plane comprise at least two elongate illumination regions between which a central elongate region with a local minimum illumination intensity is situated. For example, such a shape of the illumination pattern may be achieved if the polarization direction is set relative to the phase plate in such a way that the first regions and the second regions each cause a different phase shift in the traversing excitation light. The polarization direction set by the polarization manipulator for the first illumination pattern for the excitation light is in particular perpendicular to the polarization direction set by the polarization manipulator for the second illumination pattern for the excitation light.

The two elongate illumination regions of the second illumination pattern may be symmetrical with respect to each other in relation to a mirror axis that in the elongation direction extends centrally through the central elongate region with the local minimal illumination intensity.

Given an assumed unchanged position of the scanning unit, the central elongate illumination region of the first illumination pattern may be situated in the region in which the central elongate region with a local minimum illumination intensity of the second illumination pattern is located.

Advantageously, the directions of elongation of the first illumination pattern and of the second illumination pattern each extend perpendicular to the scanning direction.

In principle, to implement the invention, it is sufficient for the scanning unit in the illumination beam path to enable one-dimensional scanning. The scanning unit is a two-dimensional scanning unit in the case of an advantageous variant. In the direction of elongation of the illumination patterns, the scanning unit may then be actuated in order to blur and consequently average out minor unwanted artifacts of the illumination patterns. In addition to that or in an alternative, a wobble plate for providing minor pivoting of the illumination pattern in its direction of elongation may be present in the illumination beam path, in particular in an intermediate image plane or in the vicinity of an intermediate image plane.

A further preferred exemplary embodiment is characterized in that a spatial light modulator for modulating the excitation light in the back focal plane of the microscope objective is arranged in the illumination beam path in an intermediate image plane and/or in that a spatial light modulator for modulating the excitation light in a sample plane of the microscope objective is arranged in the illumination beam path in a pupil plane. This may be preferable if further manipulations of the illumination light should be performed for specific microscopy techniques, for example SIM, for the targeted illumination of specific ROIs (ROI=region of interest) and/or for the optical manipulation of the sample for specific microscopy techniques, for example STED, PALM or STORM. Expediently, the control unit may be configured to control such spatial light modulators (SLMs). Where necessary, a telescope optics unit may be present in order to provide an additional intermediate image plane and/or an additional pupil plane in the illumination beam path.

In the case of a particularly preferred configuration of the microscope according to the invention, a slot width of the camera can be set. For example, the control unit may be configured to set the slot width of the camera on the basis of a magnification of the microscope stand, i.e. a combination of the microscope objective and tube lens, on the basis of a respectively set illumination pattern and/or on the basis of a utilized phase plate. As a rule, the tube lens is not changed. Thus, the slot width of the camera may preferably be controlled on the basis of a microscope objective situated in the beam path and consequently on the basis of an objective turret control. For example, it is also possible to set the slot width differently for the first illumination pattern and for the second illumination pattern.

A substantial advantage in comparison with arrangements in which the emission light is detected in descanned fashion becomes apparent here. Adjustable apertures may also be introduced into the detection beam path of such arrangements. However, an adjustment, especially a fast adjustment, of a line aperture, which would need a length of approximately 20 mm in a microscope intermediate image and has a line aperture opening of approximately 20 μm, is non-trivial. Moreover, such a construction requires a further imaging stage in order in that case to image the line aperture onto the camera again. Finally, the jitters of two scanners are added in such solutions. All of this may be avoided using the arrangement described herein.

In an advantageous variant, the slot width of the camera is set to be smaller than a lateral spacing of the intensity maxima of the two elongate regions in the second illumination pattern on the sensor surface perpendicular to a direction of the elongation. This means that emission light which can be traced back to the two elongate regions of the second illumination pattern in the sample plane that is optically conjugate to the sensor surface of the camera is substantially not located within the slot width and consequently not located in the readout region of the camera pixels. Hence, the second illumination pattern in essence measures background light in the event of a slot width chosen thus. Hence, the measurement data obtained using the second illumination pattern may advantageously be subtracted from those measurement data that are obtained using the first illumination pattern. In particular, the slot width of the camera may be set to be smaller than 70%, preferably smaller than 50% and particularly preferably smaller than 30% of the lateral spacing of the intensity maxima of the two elongate regions of the second illumination pattern on the sensor surface perpendicular to a direction of the elongation.

A further advantageous exemplary embodiment is characterized in that for the purpose of varying an axial pose of a plane in the sample optically conjugate to a sensor surface of the camera, the detection beam path comprises a controllable optics unit with variable refractive power which may in particular be effective for all of the emission light propagating in the detection beam path to the camera. The controllable optics unit with variable refractive power may preferably be arranged in a pupil plane or in the vicinity of a pupil plane. The controllable optics unit with variable refractive power may comprise one or more of the following components or may formed by one or more of the following components: controllable gravity-compensated liquid lens (GCLL), controllable deformable mirror, electronically tunable lens (ETL), adaptive lens, spatial light modulator (SLM), TAGLENS by MITUTOYO. Varying an axial pose is understood to mean that the pose of a plane perpendicular to the optical axis and optically conjugate to the plane of the sensor surface of the camera is varied. Oscillating lenses with variable refractive power are known from MITUTOYO under the designation TAGLENS.

The feature whereby the controllable optics unit with variable refractive power is effective for all of the emission light propagating in the detection beam path to the camera is understood to mean that all of the emission light guided via the detection beam path to the camera is influenced by the controllable optics unit. In this sense, the controllable optics unit with variable refractive power may act uniformly on all of the emission light that is guided in the detection beam path to the camera. Phrased differently, it could be said that all beams that are guided from the microscope objective to the sensor surface of the camera traverse one and the same controllable optics unit with variable refractive power. This variant is based on the insight that a linear illumination focus has a greater depth of field than a point focus known from the confocal laser scanning microscope. The cross-sectional area of a punctiform beam waist increases quadratically with distance from the focal plane whereas that of a linear focus only increases linearly. Accordingly, the energy density of the excitation radiation remains comparatively high within a larger axial range in the case of a linear focus. Given a focal position of the illumination beam path in the sample, a fundamental idea of this variant may now be considered that of varying a focal position of the detection beam path by way of slightly detuning the detection beam path. Since—as explained—the energy density of the excitation light is comparatively high within a larger axial range for a linear focus, this is possible without having to accept significant losses in the image brightness.

Thus, images from planes located at different depths within the sample can be obtained without needing to modify a distance of the sample relative to the microscope objective by actuating a z-drive. Hence, the detection beam path and the camera are configured to record images of an axial sample plane that is defined by the variable focal length optics unit. This variant thus provides a potentially very fast imaging method for creating optical sections for fluorescence microscopy. A refocusing of the sample, and consequently a modification of the axial pose of the respectively measured sample plane, is potentially possible within very short times, for example within ten milliseconds. Expediently, the slight variation of the focusing may quantitatively correspond to an axial interval of a few depths of field of the microscope objective of the detection beam path in the sample, within which the energy density of the excitation light is sufficiently high. For example, the optics unit with variable refractive power may be designed such that it is possible to vary the axial depth of a focal region of the detection beam path in the sample region by more than four times the depth of field of the detection beam path in the sample region. Significant advantages in terms of speed when recording three-dimensional images may be obtained as a result. For example, it is possible to increase the speed by more than a factor of 10.

A significantly accelerated image recording with optical sectioning may advantageously be achieved for the slide scanner or slide reader according to the invention, which is generally used to examine non-living specimens. Latency times during axial focusing may be significantly reduced or removed entirely, and so for example a large substantially two-dimensional sample may be scanned quickly using a tiling method. Advantageously, a respective optimal focal plane may be set quickly in each case.

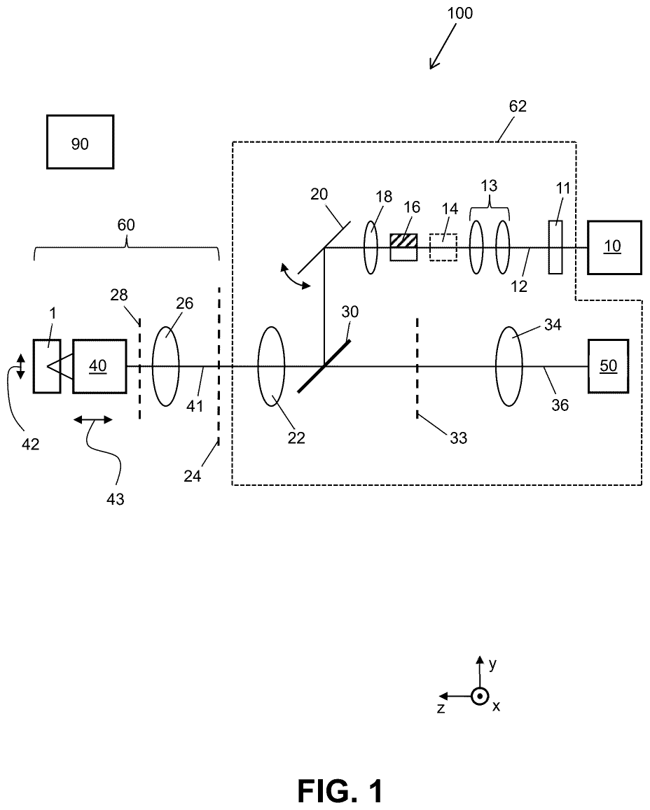

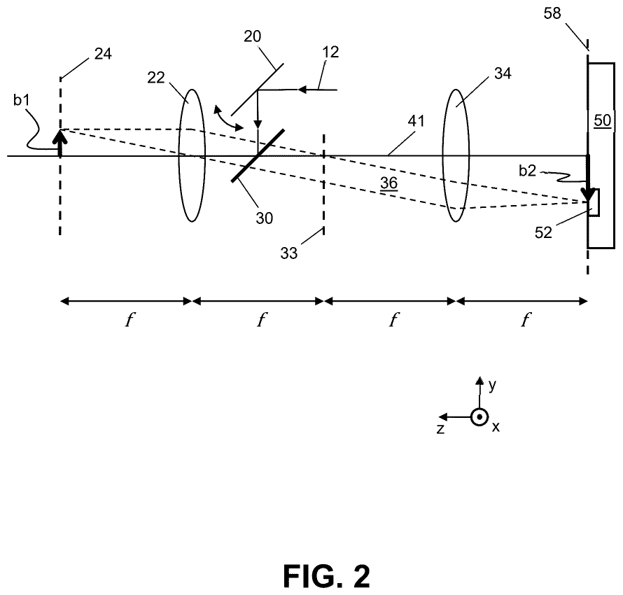

In advantageous supplementations, the detection beam path comprises an image splitter unit of the type described in DE102021134427A1, in particular in the context of FIG. 1. This image splitter unit 60 is described in DE102021134427A1, especially in paragraphs 0072 to 0085 in conjunction with FIG. 1. In addition to that or in an alternative, the detection beam path may comprise a detection unit of the type described in DE102023100926.5, in particular in the context of FIGS. 1 and 2. In addition to that or in an alternative, it is also possible that the detection beam path comprises a secondary color splitter of the type described in DE102023005252.3, in particular in the context of the figures.

In principle, the illumination beam path and the detection beam path may each have a separate tube lens. Thus, the illumination beam path and the detection beam path may each be coupled to a separate port of a microscope stand. For example, the illumination beam path may be coupled to a port of the microscope stand via a separate module, for instance a laser scanning module, with suitable illumination.

In a preferred configuration, the illumination beam path and the detection beam path comprise a common tube lens. Optionally, the excitation light and the emission light may also traverse the same intermediate image plane. A scanning optics unit in the illumination beam path may advantageously also serve to provide in the detection beam path a pupil plane for an optionally present settable optics unit with variable refractive power. In this variant, the scanning unit of the illumination beam path is upstream of a main beam splitter, and the settable optics with variable refractive power is in the detection beam path downstream of the main beam splitter.

The phase plate, the polarization manipulator, the cylindrical optics unit, the scanning unit, a main beam splitter, a scanning optics unit and the camera may advantageously be arranged in an illumination/detection module which is coupled to a camera port, in particular exactly one camera port, of a microscope stand. In a manner known in principle, the microscope stand contains the microscope objective and the tube lens. A camera port may be understood to mean a mechanical-optical interface that serves to mechanically connect e.g. an illumination/detection module to the microscope stand.

The control unit is preferably configured to control the light source, the scanning unit, the camera and the polarization manipulator in a manner synchronized with one another. In particular, the control unit may be configured to match the velocity of the slot-type stop of the camera to the angular velocity of the scanning unit and/or the detection scanning unit.

In a particularly preferred exemplary embodiment, the control unit is configured to record an image of the sample using the first illumination pattern, subsequently record an image of the sample using the second illumination pattern and finally calculate a difference between image data obtained using the first illumination pattern and the image data obtained using the second illumination pattern. As already explained above, this method allows interfering background components to be largely removed from the image. Since the illumination pattern need only be changed comparatively slowly, there are no stringent demands in respect of speed placed on the polarization manipulator in this variant. However, this variant is not well suited to an observation of fast processes, for example in living samples.

In principle, the control unit may be configured to set different illumination patterns for each time interval in which a scanning position is advanced in the sample region over a path that corresponds to a slot width of the camera. This may be advantageously performed for the observation of fast processes, for example in a living sample. In this context, a further preferred exemplary embodiment is distinguished in that the control unit is configured to switch back and forth between the first illumination pattern and the second illumination pattern in such a way that images of first line-shaped regions of the sample are recorded using the first illumination pattern, and subsequently an image of a second line-shaped region that at least partially overlaps with the respective first line-shaped region is recorded using the second illumination pattern.

In order to be able to better separate the image data in the sensor plane of the camera in the direction of the scanning direction, i.e. perpendicular to the direction of extent of the elongate illumination patterns, it may be advantageous, in particular for increasing the resolution perpendicularly in the scanning direction, if the detection beam path comprises a detection scanning unit, in particular a one-dimensional detection scanning unit, that is arranged in a pupil plane or in the vicinity of a pupil plane and synchronized with the scanning unit and the camera. An enlargement, in particular a non-optical enlargement, of the detection beam path provided by the detection scanning unit may preferably be sufficiently large so that measurement data from camera pixels in a direction transverse to the direction of extent of the linear distribution of the emission light in particular are evaluable using image scanning methods.

Advantageously, the control unit is configured to operate a detection scanning unit in the detection beam path in a manner synchronized with the scanning unit and the camera. For example, the control unit may be configured to operate the detection scanning unit at the same speed and with the same phase angle as the scanning unit. Operating the scanning unit and the detection scanning unit at the same speed and with the same phase angle is understood to mean that the maximum deflections of the scanning unit and of the detection scanning unit, i.e. the maximal deflections of the respective scanner mirrors in particular, are traversed at the same times, and the respective center positions of the angular positions are also traversed at the same times.

The same phase is understood to mean that in the event of a small deflection of the illumination pattern by the scanning unit and a consequential small deflection of the distribution of the emission light on the sensor surface of the camera, for example in the positive y-direction on the sensor surface of the camera, this distribution of the emission light is also advanced a certain amount in the same direction as a result of the effect of the detection scanning unit. A corresponding statement applies to displacements in the negative y-direction.

Thus, the detection scanning unit may be operated such that a non-optical enlargement is achieved on the sensor surface of the camera. This non-optical enlargement is given quantitatively by the ratio of the path lengths on the sensor surface of the camera in the y-direction caused by the effect of the scanning unit on the one hand and the effect of the detection scanning unit on the other.

For routine applications, it may be preferable for the microscope to be largely automated. For example, an automated or automatable supply of different samples may be present. In addition to that or in an alternative, the microscope may comprise a device for automated exchange and scanning of different samples. For example, a sample holder with a multiwell arrangement and a suitable mechanical manipulator may be present.

The microscope according to the invention may be combined with one or more of the following functional modules: quickly switchable wide-field illumination, laser scanning microscope.

Further advantages and properties of the invention are explained below with reference to the figures, in which:

FIG. 1: shows a schematic illustration of one exemplary embodiment of a microscope according to the invention;

FIG. 2: shows a partial view with further details of the microscope shown in FIG. 1;

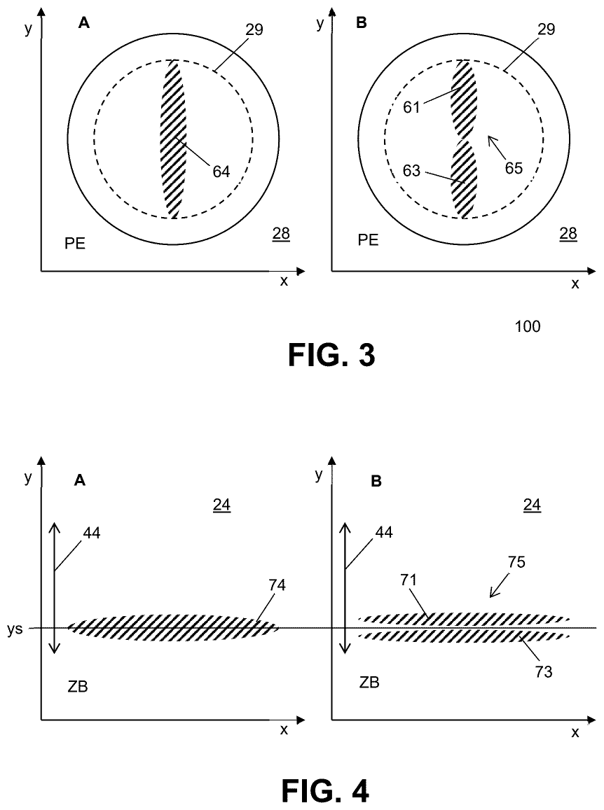

FIG. 3: shows a diagram that shows the light distribution in the pupil plane for a first and a second illumination pattern;

FIG. 4: shows a diagram that shows the light distribution in the intermediate image plane for the first and the second illumination pattern;

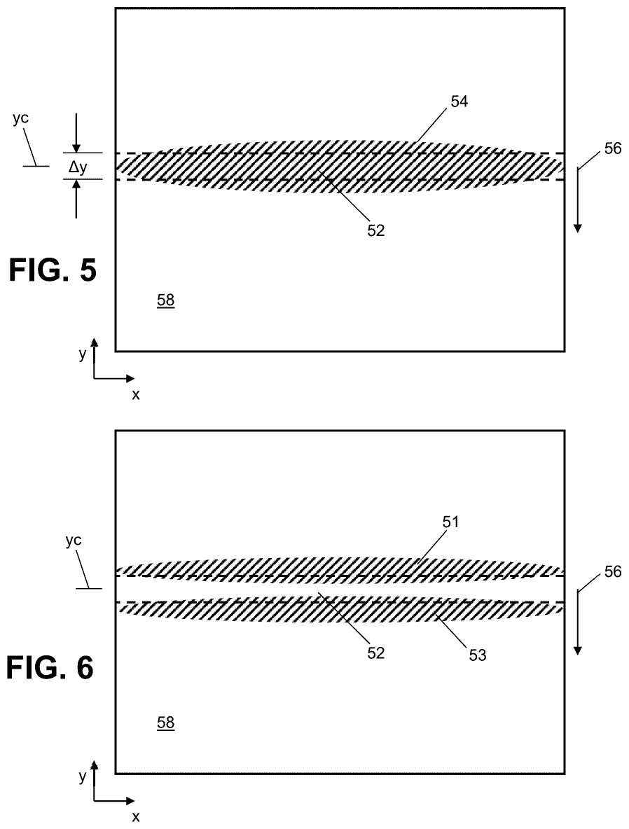

FIG. 5: shows the light distribution for the first illumination pattern in a sensor plane of the camera;

FIG. 6: shows the light distribution for the second illumination pattern in the sensor plane of the camera;

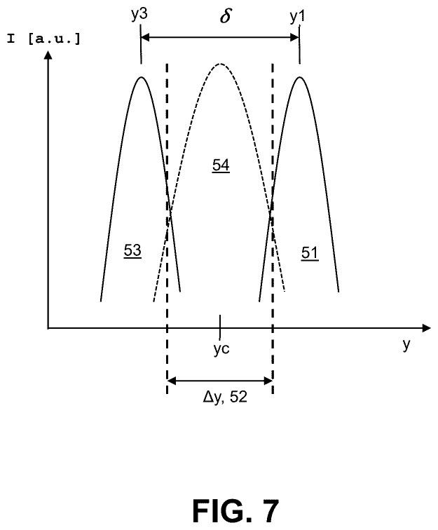

FIG. 7: shows a diagram for illustrating the expedient choice of a slot width of the camera;

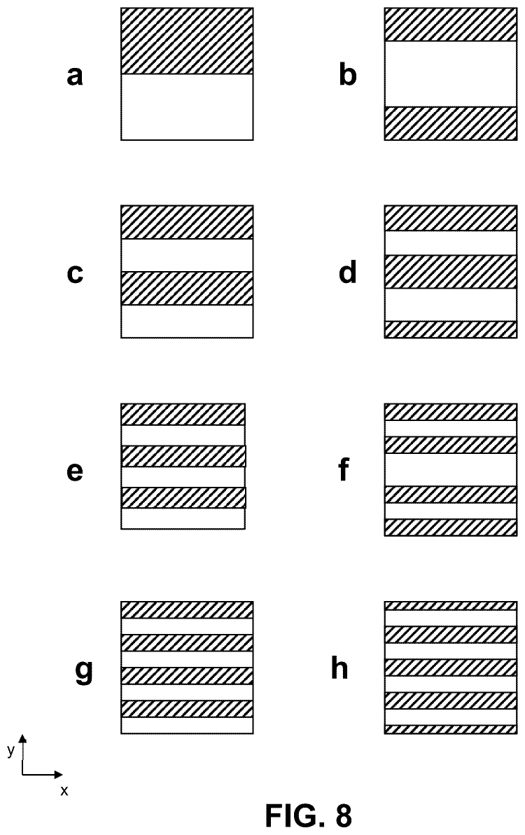

FIG. 8: shows a schematic illustration of different phase plates that are suitable for use in a microscope according to the invention;

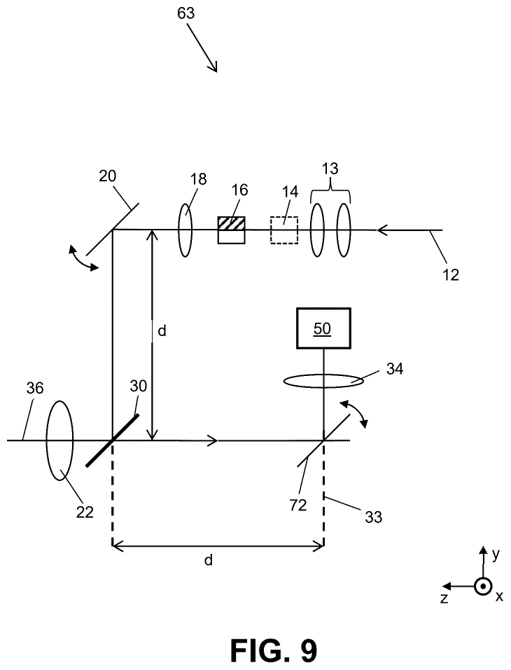

FIG. 9: shows a schematic illustration of a variant of an illumination/detection module for the microscope according to the invention in FIG. 1;

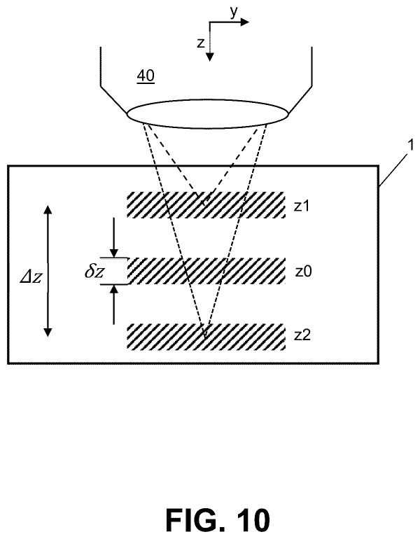

FIG. 10: shows a partial view of the microscope from FIG. 1 for illustrating properties of a preferred exemplary embodiment; and

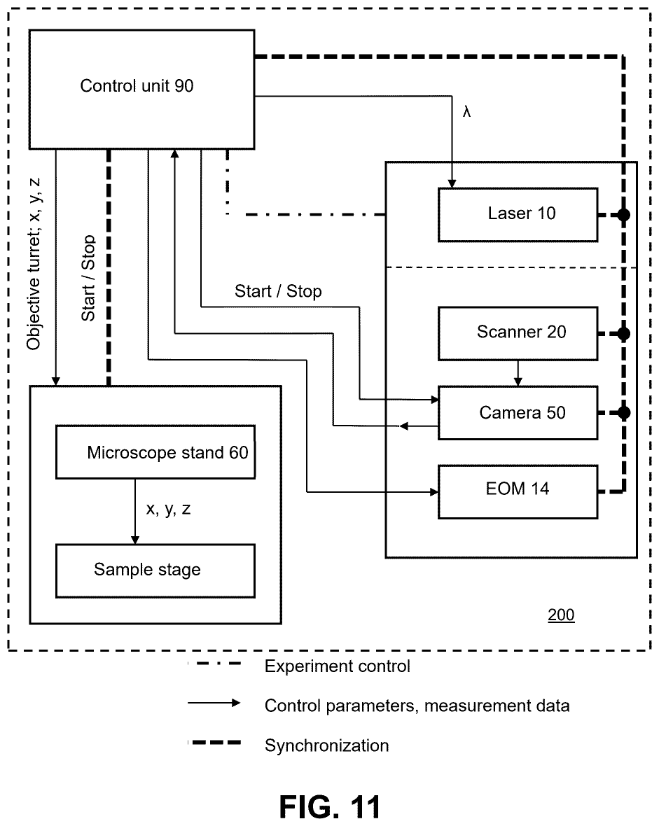

FIG. 11: shows a schematic illustration of one block diagram of a microscope according to the invention.

Components that are the same or act in the same way are generally identified by the same reference signs in the figures.

One exemplary embodiment of a microscope 100 according to the invention will be explained below with reference to FIGS. 1 to 8. According to the invention, the microscope 100 as shown schematically in FIG. 1 has firstly a light source 10 for transmitting excitation light 12 and an illumination beam path for guiding the excitation light 12 into a sample region 1. According to the invention, the illumination beam path comprises a controllable polarization manipulator 14 for modifying a polarization state of the excitation light 12, a phase plate 16 for creating an illumination pattern, a cylindrical optics unit 18 for creating an elongate distribution of the excitation light 12, a scanning unit 20 for at least one-dimensionally scanning the elongate distribution of the excitation light 12 through the sample region 1 and an illumination objective 40 for guiding the excitation light 12 into the sample region 1. Subsequently, according to the invention, the microscope 100 comprises a camera 50 for recording images of a sample in the sample region 1 and a detection beam path with a microscope objective 40 for guiding emission light 36, which was radiated by the sample, onto the camera 50. According to the invention, a control unit 90 is present for controlling the scanning unit 20 and/or the camera 50 and for reading out measurement data from the camera 50. According to the invention, the camera 50 is arranged in a non-descanned part of the detection beam path, and, according to the invention, the control unit 90 is configured to synchronize a location yc (see FIGS. 5 and 6) of a slot-shaped readout region 52 in a sensor plane 58 of the camera 50 with a location ys (see FIG. 4) of the elongate distribution of the excitation light 12 in a plane of the sample. In the exemplary embodiment shown, the illumination objective 40 and the microscope objective 40 are one and the same objective.

The components within the dashed line 62 may advantageously be combined in an illumination/detection module that may be coupled to a single camera port (not depicted in the figure) of a microscope stand (reference sign 60).

The control unit 90 is suitably operatively connected, typically via cables not depicted in the figures, to those components that it is configured to control and whose measurement data it evaluates.

The light source 10 may preferably be a laser module having a plurality of lasers and preferably supplies collimated linearly polarized light. Optionally, a polarizer 11 that linearly polarizes the excitation light 12 may be present. A zoom optics unit 13 for setting a beam diameter is present in the exemplary embodiment shown. In the exemplary embodiment shown, the controllable polarization manipulator 14 is a controllable electro-optic manipulator. Alternatively, a liquid crystal manipulator could also be used; however, it only allows lower switching rates. Switchover frequencies of the polarization manipulator in the MHz range are required in known point-scanning systems. Since line-scanning systems are parallelized on the order of a factor of 1000, a modulation frequency in the range of a few kHz is sufficient here.

The cylindrical optics unit 18 may consist of a single cylindrical lens which, in the plane in which the scanning unit 20 is arranged, creates an elongate, i.e. oblong, distribution of the excitation light 12 that extends in the y-direction. The scanning unit 20 may be formed by a two-dimensional scanner, for example two galvanometric scanners or one two-axis MEMS scanner. The effective area of the scanning unit 20 is arranged in a pupil plane of the illumination beam path, i.e. in a plane that is optically conjugate to a back focal plane 28 of the microscope objective 40. The specific look of the elongate oblong distribution of the excitation light depends on the polarization state of the excitation light 12 that is set by the polarization manipulator 14 by way of controlling the control unit 90.

In principle, the spatial modulation of the excitation light 12 is implemented like in DE102011013613A1. What is essential here is that different regions of the phase plate 16 are structured in such a way that there is a different phase shift in each case. For example, this may be created with crystal optics as used in the polarization optics unit. Ultimately, these create a phase shift that depends on the polarization. If the phase plate 16 is designed such that different spatial regions with specific phase shifts are created, then the beam of the excitation light 12 may be subject to a spatially variable phase modulation along its cross section. Specifically:

The phase plate 16 is arranged perpendicular to the optical axis and may for example be one of the phase plates illustrated schematically in FIGS. 8a to h. The phase plates in FIGS. 8a to h are plane-parallel plates and comprise a stripe-like arrangement of first regions (depicted with hatching) and second regions (depicted without hatching), wherein the first regions and second regions may each constitute an equal fraction of the total area of the phase plate. Details regarding such phase plates are described on page 036008-3 in [Shen]. The stripe-shaped regions of the phase plate 16 extend in the x-direction in FIG. 1. A right-hand Cartesian coordinate system is plotted in FIG. 1.

The second region or the second regions of the phase plate 16 may be formed by glass for example such that a phase shift impressed on the traversing excitation light 12 does not depend on a polarization direction of the excitation light 12. In the example shown, the first region or the first regions of the phase plate 16 are each formed by the same birefringent material and are each natured such that a phase shift impressed on the incoming excitation light 12 has the same magnitude as the phase shift experienced by the incident excitation light 12 upon traversal through the second region or the second regions should the excitation light 12 be polarized parallel to the x-axis. Then again, should the excitation light 12 be polarized in the direction of the y-axis, the excitation light experiences, in comparison with the traversal through the second region or the second regions, a different phase shift upon traversal through the first region or the first regions on account of its or their birefringent character.

On account of the differences in the phase shifts caused in each case, the components of the excitation light 12 transmitted firstly through the first region or first regions of the phase plate 16 and secondly through the second region or second regions of the phase plate 16 interfere differently in the back focal plane 28 depending on whether the excitation light 12 is polarized in the x- or in the y-direction, and so different illumination patterns arise in the back focal plane 28 of the microscope objective 40. Examples in this respect are explained with reference to FIG. 3.

FIG. 3A shows a first illumination pattern 64 in the pupil plane 28 (PE), which in essence consists of a single elongate illumination spot 64 that substantially extends to the radial edge of the objective pupil 29 in the y-direction. This illumination pattern is obtained should the excitation light 12 be polarized parallel to the x-axis. Since the back focal plane 28 of the microscope objective 40 is optically conjugate to the plane in which the scanning unit 20 is situated, the distribution of the excitation light 12 in the plane of the scanning unit 20 substantially looks like what is shown in FIG. 3A.

FIG. 3B shows a second illumination pattern 65 in the pupil plane 28 (PE), which in essence consists of a first elongate illumination spot 61 and a second elongate illumination spot 63, both of which extend in the y-direction. In this case, the first elongate illumination spot 61 extends from the center of the objective pupil 29 to its upper edge, and the second elongate illumination spot 63 extends from the lower edge of the objective pupil 29 to its center. Since the back focal plane 28 of the microscope objective 40 is optically conjugate to the plane in which the scanning unit 20 is situated, the distribution for the second illumination pattern 65 of the excitation light 12 in the plane of the scanning unit 20 substantially looks like what is shown in FIG. 3B.

Excitation light 12 reflected off the scanning unit 20 is guided from the main beam splitter 30, for example a dichroic beam splitter, via the scanning optics unit 22, which for example may be realized by a glass lens with a focal length f (see FIG. 2), into the intermediate image plane 24. Details regarding the optical arrangement are illustrated in FIG. 2. As evident there, the scanning optics unit 22 is arranged at a distance of its focal length f from the intermediate image plane 24. The scanning unit 20 is also arranged at a distance f from the scanning optics unit 22 (not shown in FIG. 2), and so the effect of the scanning optics unit 22 results in the illumination patterns of the excitation light 12 present in the plane of the scanning unit 20 being spatially Fourier transformed into the intermediate image plane 24.

The illumination patterns present in the intermediate image plane (ZB) 24 are depicted schematically in FIG. 4. FIG. 4A shows the first illumination pattern 74 in the intermediate image plane 24 that can be traced back to the first illumination pattern 64 in the pupil plane of the scanning unit 20 (see FIG. 3A). FIG. 4B shows the second illumination pattern 75 in the intermediate image plane 24 that can be traced back to the second illumination pattern 65 in the pupil plane of the scanning unit 20 (see FIG. 3B). Since the intermediate image plane 24 is optically conjugate to an object plane in the sample region 1, the illumination patterns 74, 75 shown in FIGS. 4A and 4B are the distributions of the excitation light 12 that are implemented in the object plane, i.e. in a sample to be examined. As illustrated by the double-headed arrow 44, the illumination patterns are scanned through the intermediate image plane 24 in the y-direction by actuating the scanning unit 20 and hence are scanned through the object plane in the same way. In order to compensate for possible artifacts in the illumination patterns, the scanning unit 20 may quickly scan the illumination patterns back and forth in the x-direction, optionally with a small amplitude in each case.

The first illumination pattern 74 in the intermediate image plane 24 in essence consists of an elongate region that extends in the x-direction. The second illumination pattern 75 in the intermediate image plane 24 in essence consists of a first elongate illumination spot 71 and a second elongate illumination spot 73, which likewise extend in the x-direction. In this case, each region 74, 71 and 73 represents a region of comparatively high intensity of the excitation light 12. The intensity of the excitation light 12 drops off quickly outside of these regions.

FIGS. 4A and 4B show the illumination patterns for an identical position of the scanning unit 20. As evident, the first illumination pattern 74 extends substantially in elliptical fashion, i.e. symmetrically to a y-coordinate of the intensity maximum that is denoted ys. The two elongate illumination spots 71 and 73 are located above and below the line ys, respectively.

Via a tube lens 26 and the microscope objective 40, the illustrated illumination patterns 74 or 75 are guided into the sample region 1 and are scanned there along the y-direction using the scanning unit 20, as illustrated in FIG. 4 (double-headed arrow 44). An optical axis is identified by the reference sign 41. In particular, a sample arranged in the sample region 1 may be arranged on an xy-sample stage, which is controllable by the control unit 90. Using the xy-sample stage, it is possible to drive a desired region of the sample into the field of view of the microscope objective 40 (double-headed arrow 42). An axial distance of the sample relative to the microscope objective 40 may be set as desired by actuating a z-drive that is also controllable by the control unit 90 (double-headed arrow 43). Emission light 36 that is radiated by the sample as a consequence of the application of the excitation light 12 is received by the microscope objective 40 and guided via the detection beam path onto the camera 50. Via the scanning optics unit 22, the emission light 36 reaches the main beam splitter 30, is transmitted through the latter and reaches the sensor surface 58 of the camera 50 via a pupil plane 33 and a camera objective 34. As illustrated in FIG. 2, a first image b1 of an object in the sample region 1 in the intermediate image plane 24 is imaged into a second image b2 in the sensor plane 58 of the camera 50 by way of 4f imaging in the illustrated exemplary embodiment using the scanning optics unit 22 and the camera objective 34. Consequently, the sensor plane 58 of the camera 50 is optically conjugate to the intermediate image plane 54 and to the corresponding object plane in the sample region 1.

FIGS. 5 and 6 schematically show the sensor surface 58 and a respective readout region 52 of sensor pixels which is situated between the two parallel horizontal dashed lines and which is moved in the y-direction (arrow 56) in a manner synchronized with the scanning unit 20. This gives rise to the feature that the camera is arranged in the non-descanned part of the detection beam path. FIG. 5 shows a distribution 54 of emission light 36 on the sensor surface 58 of the camera 50, as generated by the first illumination pattern 74 in the sample space 1. As can be seen, the readout region 52 of the camera pixels is located substantially centrally on this distribution 54. FIG. 6 shows a distribution 51, 53 of emission light 36 on the sensor surface 58 of the camera 50, as generated by the second illumination pattern 75 in the sample space 1. This distribution has a distribution 51 of the emission light 36 caused by the first elongate illumination spot 71 of the second illumination pattern 75 and a distribution 53 of the emission light 36 caused by the second elongate illumination spot 73 of the second illumination pattern 75.

As can be seen, the readout region 52 of the camera pixels is located substantially centrally between the distributions 51 and 53.

Since the sensor plane 58 is optically conjugate to the intermediate image plane 24 and to the object plane in the sample region 1, the contour of the distribution 54 substantially reproduces the first illumination pattern 74, and the contours of the distributions 51 and 53 substantially reproduce the second illumination pattern 75. The control unit 90 is configured to synchronize the location yc (see FIGS. 5 and 6) of the slot-shaped readout region 52 in the sensor plane 58 of the camera 50 with the location ys (see FIGS. 5 and 6) of the elongate distribution of the excitation light 12 in a plane of the sample.

A width Δy of the readout region 52 may advantageously be set in a manner dependent on the set objective 40 and/or in a manner dependent on the illumination pattern and/or the phase plate 16 chosen in each case. Details in this respect are explained in conjunction with FIG. 7. FIG. 7 shows a diagram in which the intensity of the distributions 54, 51 and 53 of the emission light 36 are schematically plotted against the y-coordinate.

As can be seen, the maximum of the intensity of the distribution 54, which corresponds to the first illumination pattern 74, is located at the location yc on the y-axis (cf. FIG. 5). The limits of the readout region 52 of camera pixels are illustrated using vertical dashed lines that extend symmetrically with respect to the location yc of the maximum and which are spaced apart by Δy. The intensity maximum of the distribution 53 is located at y3, and the intensity maximum of the distribution 51 is located at y1. y3 and y1 are located on the y-axis, symmetrically to the left and right of yc (cf. FIG. 6). The width Δy of the readout region 52 is approximately 60% of the difference δ between y1 and y3.

The aspects set forth below should be taken into account for a particularly accurate functionality of the microscope according to the invention and of the method according to the invention. By preference, the phase plate 16 is aligned with respect to an axis of rotation parallel to the optical axis such that the arising elongate illumination patterns 74, 75 and the distributions 54, 51, 53 of emission light 36 generated thereby (see FIGS. 4, 5 and 6) are oriented as accurately as possible in the direction of the slot-like readout region 52 on the sensor surface 58 of the camera 50. That is to say, in the pupil, the phase plate 16 should be oriented such that the first illumination pattern 64 and the second illumination pattern 65 are oriented as accurately as possible in the y-direction. Thus, the stripe-shaped regions of the phase plate from FIG. 1 should be oriented as accurately as possible in the x-direction.

Moreover, the modulation depth should be as good as possible. In particular, the intensity should be as low as possible in the region of locally minimal intensity between the first elongate illumination spot 71 of the second illumination pattern 75 in the intermediate image plane 24 and the second elongate illumination spot 73 of the second illumination pattern 75 in the intermediate image plane 24 (see FIG. 4B).

### Physical Description of the Method

The starting point for the description of our system is wide-field imaging without linear illumination and without a confocal stop, wherein the intensity PSF is given by Hₑₘ(x). Moreover, discussion will be limited to the one-dimensional case since there is wide-field imaging in the perpendicular direction in our arrangement. This is an approximation which assumes that the PSF dependence in the two directions can be separated and the PSF can be written as a product. This approximation was used in e.g. [PARRA]. It could also be argued that the behavior of the microscope in the y-direction (perpendicular to the line) is considered first, while the sample is assumed to be a one-dimensional structure in the direction of the scanning line. Moreover, without loss of generality, an optical magnification of V=1 is assumed for simplification.

$$B ( {x}_{D} ) = \int {dx}_{O} {H}_{em} ( {x}_{D} - {x}_{O} ) O ( {x}_{O} ) \qquad ( 1 )$$

If the sample is scanned with a line in the positive x-direction, the following intensity distribution arises:

$$O ( {x}_{O} ) = \hat{O} ( {x}_{o} ) {H}_{ex} ( {x}_{O} - {x}_{S} ) , \qquad ( 2 )$$

where the scanning vector is denoted by x_{S}. Since only the one-dimensional case is considered, x_{S} is a scalar.

$$B ( {x}_{D} , {x}_{S} ) = \int {dx}_{O} {H}_{ex} ( {x}_{S} - {x}_{O} ) {H}_{em} ( {x}_{D} - {x}_{O} ) \hat{O} ( {x}_{o} ) \qquad ( 3 )$$

The intensity distribution in the detection plane B(x_{D}) is obtained by scanning over the object plane, i.e. the integral ∫ dx_{S}B(x_{D}, x_{S}). Since the scanning vector x_{S} only occurs in the excitation PSF, the integral yields the following:

$$B ( {x}_{D} ) = \int {dx}_{O} {H}_{em} ( {x}_{D} - {x}_{O} ) \hat{O} ( {x}_{o} ) \int ds {H}_{ex} ( {x}_{S} - {x}_{O} ) \qquad ( 4 )$$

in this case a constant multiplied by the wide-field image.

$$B ( {x}_{D} ) = K \int {dx}_{O} {H}_{em} ( {x}_{D} - {x}_{O} ) \hat{O} ( {x}_{o} ) \qquad ( 5 )$$

This should be expected.

### Confocal Imaging

By contrast, the following picture arises if the confocal case is considered: On account of the detection with the rolling shutter, the confocal line aperture is found directly in the detection plane. The light distribution incident there is multiplied by this stop distribution D(x′_{S}).

$$B ( {x}_{D} , {x}_{S} ) = D ( {x}_{D} - {x}_{S} ) \int {dx}_{o} {H}_{ex} ( {x}_{S} - {x}_{O} ) {H}_{em} ( {x}_{D} - {x}_{O} ) \hat{O} ( {x}_{o} ) \qquad ( 6 )$$

The intensity distribution in the detection plane B(x_{D}) is once again obtained by scanning over the object plane, i.e. the integral ∫ dx_{S}B(x_{D}, x_{S}). The confocal line aperture that is scanned synchronously with the scan of the excitation line, i.e. likewise with x_{S}, is found directly in the detection plane on account of the detection with the rolling shutter.

$$B ( {x}_{D} ) = \int \int {dx}_{S} {dx}_{O} {H}_{e x} ( {x}_{S} - {x}_{O} ) {H}_{em} ( {x}_{D} - {x}_{O} ) \hat{O} ( {x}_{o} ) D ( {x}_{D} - {x}_{S} ) \qquad ( 7 )$$

For D(x)=δ(x), the following is then obtained

$$B ( {x}_{D} ) = [ ( {H}_{ex} {H}_{em} ) ⊗ \hat{O} ] ( {x}_{O} ) \qquad ( 8 )$$

and under the assumption that Hₑₓ(x)=Hₑₘ(x) which if the Stokes shift etc. is neglected is justified since moreover the objective makes the largest contribution here:

$$B ( {x}_{D} ) = [ {H}^{2} ⊗ \hat{O} ] ( {x}_{D} ) \qquad ( 9 )$$

For D(x)=δ(x), a confocal image with the correspondingly increased resolution of a confocal system is thus obtained. This form may also be compared with equation 4e in [STROEHL] (SOLIS). However, like in the point-scanning system, too, this is disadvantageous to the effect of obtaining little light on the sensor and hence a poor SNR (SNR=signal-to-noise ratio).

The object may also be considered to be a point source in equation (7), and hence it is possible to calculate the point spread function for finite confocal stop D:

$$B ( {x}_{D} ) = {H}_{conf} ( {x}_{D} ) = \int \int {dx}_{S} {dx}_{O} {H}_{ex} ( {x}_{S} - {x}_{O} ) {H}_{em} ( {x}_{D} - {x}_{O} ) δ ( {x}_{O} ) D ( {x}_{D} - {x}_{S} ) \qquad ( 10 )$$

Hence, a convolution of the slot function with a confocal PSF is obtained as point spread function:

$${H}_{conf} ( {x}_{D} ) = \int {dx}_{S} {H}_{ex} ( {x}_{S} ) {H}_{em} ( {x}_{D} ) D ( {x}_{D} - {x}_{S} ) = {H}_{em} ( {x}_{D} ) \int {dx}_{S} {H}_{ex} ( {x}_{S} ) D ( {x}_{D} - {x}_{S} ) \qquad ( 11 )$$

or more compactly

$${H}_{conf} ( {x}_{D} ) = {H}_{em} [ {H}_{ex} ⊗ D ] ( {x}_{D} ) \qquad ( 12 )$$

Since, like in (9) and (12), the effective point spread function contains a product of excitation and detection function, this now yields that a modulation of the excitation light distribution Hₑₓ(x) vis-à-vis a fixed stop function D and the detection PSF leads to a modulation of the semi-confocal intensity PSF H_{conf}(x_{D}), which substantially modulates the components from the focal plane. The combination of the two images by calculation in accordance with the procedure of the focal modulation now leads to the suppression of the constant component, which is based on the background light, i.e. disturbance light, and is modulated less or not at all.

This combination by calculation may be a type of lock-in, if this is supported by the camera. To this end, the camera must be read quickly enough, which is a capability increasingly offered by modern sCMOS cameras. In this context, the speed may be particularly high if the imaging is restricted to only a few lines. Furthermore, novel cameras based on the SPAD array technology are ideally suited to measurements of this type since they are very sensitive on the one hand and can be read out very quickly on the other, allowing a demodulation of the signals. SPAD512 by PI Imaging Technology is mentioned here by way of example.

The detection method is very much simplified if the modulation of the PSF is only carried out image-by-image. In this case, it is only necessary to subtract two images, respectively with a “good” PSF (i.e. with the first illumination pattern for example) and a “bad” PSF (i.e. with the second illumination pattern for example), from one another, possibly using a weighting factor α.

$$B ( x , y ) = {B}_{g} ( x , y ) - α {B}_{s} ( x , y ) \qquad ( 13 )$$

Hence, these two images are recorded in a plane in quick succession and combined by calculation. In principle, this could also be implemented stack-by-stack, by virtue of recording an entire image stack with a “good” PSF and a “bad” PSF and carrying out a similar procedure. Naturally, a disadvantage here is that changes in the sample during this time are quite probable and lead to artifacts. It is advantageous if the two signals to be combined by calculation (lines, partial images, images or stacks) are recorded in the quickest possible succession.

FIG. 9 schematically shows an alternative illumination/detection module 63 which may be part of a microscope according to the invention. Only the differences in comparison with FIG. 1 are explained here. In addition to the structure in FIG. 1, a detection scanning unit 72, which may be a one-dimensional galvanometric or MEMS scanner, is present in the detection beam path of FIG. 9. The detection scanning unit 72 serves to additionally scan the distributions of the emission light 36 on the sensor plane 58 of the camera 50 in the y-direction. In this context, it should be observed that the deflection of the optical axis through 90° at the detection scanning unit also rotates the coordinate system through 90°.

The detection scanning unit 72 is arranged in the pupil plane 33, i.e. it has the same distance d from the main beam splitter 30 as the scanning unit 20. The detection scanning unit 72 serves the better separation of image data in the sensor plane 58 of the camera in the direction of the scanning direction, i.e. perpendicular to the direction of extent of the elongate illumination patterns. A non-optical enlargement so to speak, provided thus, of the detection beam path may preferably be sufficiently large so that measurement data from camera pixels in a direction transverse to the direction of extent of the elongate distributions of the emission light in particular are evaluable using image scanning methods. Using the detection scanning unit 72, it is also possible to implement variants in which the control unit 90 is configured to set different illumination patterns for each time interval in which a scanning position is advanced in the sample region over a path that corresponds to a slot width Δy of the camera 50. This may be advantageously performed for the observation of fast processes, for example in living samples. For example, the control unit 90 may configured to switch back and forth between the first illumination pattern 74 and the second illumination pattern 75 in such a way that images of first line-shaped regions of the sample are recorded using the first illumination pattern 74, and subsequently an image of a second line-shaped region that at least partially overlaps with the respective first line-shaped region is recorded using the second illumination pattern 75.

However, the data evaluation here is not as simple as in the variants in which images of a whole plane are initially recorded with the first illumination pattern 74 and subsequently recorded with the second illumination pattern 75, or vice versa.

In a further advantageous variant, which is not shown in the figures, a controllable optics unit with variable refractive power, for example an ETL (ETL=electronically tunable lens), is present in the detection beam path, in the pupil plane 33 or in the vicinity of this plane and serves to vary an axial pose z0, z1, z2 of an object plane in the sample 1 optically conjugate to the sensor surface 58 of the camera 50.

This is illustrated schematically in FIG. 10, which depicts the microscope objective 40 and a sample 1. As a result of the effect of the ETL, a focal region imaged onto the sensor plane 58 of the camera 50 may be adjusted in the range between the axial planes z1 and z2. z0 denotes a central plane. As can be seen, the entire axial shift Δz possible is a multiple of an optical depth of field δz of the detection beam path. It is also possible to introduce an optics unit with variable refractive power, for example an ETL, upstream of the main beam splitter 30 in the illumination beam path and operate said optics unit with variable refractive power in a manner synchronized with the ETL in the detection arm. An additional extension of the axial working range is possible if the optics unit with variable refractive power is moreover capable of correcting further aberrations, in particular spherical aberrations. For example, this is possible using spatial light modulators (SLMs) and/or adaptive lenses. Using such arrangements, it is possible in particular to correct spherical aberrations arising due to the defocusing, and larger axial displacements of the observed sample plane may be meaningfully implemented.

FIG. 11 shows a schematic block illustration of an exemplary embodiment of a microscope 200 according to the invention, having a light source (laser 10), a scanning unit (scanner 20), a camera 50, a polarization manipulator (EOM 14), a microscope stand 60 with a sample stage, and a control unit. Although not shown in detail, the microscope stand 60 comprises a controllable objective turret having a plurality of microscope objectives. The sample stage is a controllable xy-sample stage, on which a sample may be arranged. A distance between the microscope objective and the sample stage may be adjusted by a controllable z-drive, which is likewise not depicted here. The control unit 90 is initially configured to control the laser 10, the scanning unit 20, the camera 50 and the polarization manipulator 14 in synchronized fashion, i.e. with a defined time reference in each case. This is illustrated by the thick dashed line. In the case of the light source 10, the control unit 90 may optionally also set a wavelength λ. Moreover, the control unit 90 is configured to select a specific microscope objective and use the xy-sample stage and the z-drive to set a desired xyz-position of the sample relative to this microscope objective. Finally, the control unit 90 is configured to read out measurement data from the camera 50. The flow directions of control parameters and measurement data are depicted by arrows in each case. General experiment control is illustrated by a dash-dotted line.

The present invention provides a compact arrangement for high-resolution microscopy with improved suppression of out-of-focus light by modulating the excitation light and is particularly suitable for the examination of thick samples.

### LIST OF REFERENCE SIGNS

1 Sample, sample region
10 Light source, laser
11 Polarization filter, optional
12 Excitation light
13 Beam-expanding optics unit, telescope optics unit, zoom optics unit
14 Polarization manipulator, Polarization-rotating device, EOM
16 Phase plate
18 Cylindrical optics unit
20 Scanning unit, for example a MEMS scanner or galvo scanner
22 Scanning optics unit, for example spherical lens
24 Intermediate image plane
26 Tube lens, for example spherical lens
28 Back focal plane of microscope objective 40, pupil plane
29 Outer edge of the pupil
30 Main beam splitter
33 Pupil plane
34 Camera objective
36 Emission light radiated by sample 1 as a result of illumination with excitation light 12, fluorescence
40 Microscope objective
41 Optical axis
42 Adjustment option in x- and y-direction, for example with xy-displacement stage, xy-sample stage
43 Axial adjustment option, for example using z-drive of the microscope objective 40 or of the microscope stand 60
44 Scanning direction
50 Camera
51 Distribution of emission light 36 on the sensor surface 58 of the camera, caused by the first elongate illumination spot 71 of the second illumination pattern 75
52 Readout region of sensor surface 58
53 Distribution of emission light 36 on the sensor surface 58 of the camera 50, caused by the second elongate illumination spot 73 of the second illumination pattern 75
54 Distribution of emission light 36 on the sensor surface 58 of the camera 50, caused by the first illumination pattern 74
56 Movement direction of the readout region 52
58 Sensor surface of the camera 50
60 Microscope stand
62 Illumination/detection module
61 First elongate illumination spot of second illumination pattern 65 in pupil plane 28
63 Second elongate illumination spot of second illumination pattern 65 in pupil plane 28
64 First illumination pattern in the pupil plane 28, an elongate illumination spot
65 Second illumination pattern in pupil plane 28, two collinear elongate illumination spots 61, 63
71 First elongate illumination spot of second illumination pattern 75 in intermediate image plane 24
72 Detection scanning unit, for example MEMS scanner
73 Second elongate illumination spot of second illumination pattern 75 in intermediate image plane 24
74 First illumination pattern in intermediate image plane 24 and in sample plane, an elongate illumination spot
75 Second illumination pattern in the intermediate image plane 24, two elongate illumination spots 71, 73 offset in parallel with one another in scanning direction 44
90 Control unit, for example PC, for controlling the scanner 20 and the camera
50 and for evaluating measurement data from the camera 50
100 Microscope according to the invention
200 Microscope according to the invention
b1 Image size in intermediate image plane 24
b2 Image size in sensor plane 58 of camera 50
d Distance between scanning unit 20 and main beam splitter 30, distance between the main beam splitter 30 and detection scanning unit 72
f Focal length of scanning optics unit 22 and camera objective 34
PE Pupil plane
x, y, z Right-handed orthogonal coordinate system
y1 Location in the y-coordinate of the intensity maximum of the distribution 51 of emission light 36 on the sensor surface 58
y3 Location in the y-coordinate of the intensity maximum of the distribution 53 of emission light 36 on the sensor surface 58
ys Location in the y-coordinate of the intensity maximum of the distribution 74 of the excitation light 12 in the sample plane
yc Location in the y-coordinate of the intensity maximum of the distribution 54 of emission light 36 on the sensor surface 58
ZB Intermediate image plane
δ y1-y3
Δy Slot width of the camera 50, lateral width of the readout region 52, electronically adjustable
z0 Central plane in sample 1
z1 First plane in sample 1
z2 Second plane in sample 1
Δz Possible axial shift
δz Optical depth of field of the detection beam path

### REFERENCES

[PANT] S. Pant, Y. Duan, F. Xiong, and N. Chen, “Augmented line-scan focal modulation microscopy for multi-dimensional imaging of zebrafish heart in vivo,” Biomed. Opt. Express 8, 5698-5707 (2017),
   https://doi.org/10.1364/BOE.8.005698
[CHEN] N. Chen, C. Wong, and C. Sheppard, “Focal modulation microscopy,” Opt. Express 16, 18764-18769 (2008),
   https://doi.org/10.1364/OE. 16.018764
[GAO] G. Gao, S. Chong, C. Sheppard, and N. Chen, “Considerations of aperture configuration in focal modulation microscopy from the standpoint of modulation depth,” J. Opt. Soc. Am. A 28, 496-501 (2011),
   https://doi.org/10.1364/JOSAA.28.000496
[SHEN] Shuhao Shen, Shilpa Pant, Rui Chen, Nanguang Chen, “Effects of pupil filter patterns in line-scan focal modulation microscopy,”
   J. Biomed. Opt. 23 (3), 036008 (2018), doi: 10.1117/1.JBO.23.3.036008
[PARRA] J. Parravicini, L. Tartara, E. Hasani, A. Tomaselli, “Fast calculation of the line-spread-function by transversal directions decoupling”,

### J. Opt. 18 075609, doi: 10.1088/2040-8978/18/7/075609

[STROEHL] F. Ströhl, D. Hansen, M. Nager Grifo, and Å. Birgisdottir, “Multifocus microscopy with optical sectioning and high axial resolution,”
   Optica 9, 1210-1218 (2022), https://doi.org/10.1364/OPTICA.468583
DE102011013613A1
WO2023117236A1
DE102021134427A1
DE201210010207A1
DE 10 2023 100 926.5
DE 10 2023 005 252.3

1. A microscope, comprising:
a light source for transmitting excitation light,
an illumination beam path for guiding the excitation light into a sample region, wherein the illumination beam path comprises a controllable polarization manipulator for modifying a polarization state of the excitation light, a phase plate for creating an illumination pattern, a cylindrical optics unit for creating an elongate distribution of the excitation light, a scanning unit for at least one-dimensionally scanning the elongate distribution of the excitation light through the sample region and an illumination objective for guiding the excitation light into the sample region,
a camera for recording images of a sample in the sample region,
a detection beam path with a microscope objective for guiding emission light, which was radiated by the sample, onto the camera and a control unit for controlling the scanning unit and/or the camera and for reading out measurement data from the camera,
wherein
the camera is arranged in a non-descanned part of the detection beam path and
the control unit is configured to synchronize a location of a slot-shaped readout region in a sensor plane of the camera with a location of the elongate distribution of the excitation light in a plane of the sample.

2. The microscope as claimed in claim 1,
wherein
the phase plate comprises a stripe-like arrangement of in each case at least one first region and at least one second region, which are aligned parallel to one another and in each case perpendicular to the optical axis, wherein the at least one first region is formed by a birefringent material and the at least one second region is formed by a non-birefringent material.

3. The microscope as claimed in claim 1,
wherein
the polarization manipulator comprises at least one of the following components or is formed by one of these components: controllable liquid-crystal manipulator, controllable electro-optic manipulator.

4. The microscope as claimed in claim 1,
wherein
the illumination beam path comprises one of the following components upstream of the polarization manipulator: settable telescope optics unit, zoom optics unit for setting a beam diameter of the excitation light.

5. The microscope as claimed in claim 1,
wherein
a first illumination pattern in an intermediate image plane comprises at least one central elongate illumination region which comprises a local or absolute maximum of the illumination intensity.

6. The microscope as claimed in claim 1,
wherein
a second illumination pattern in an intermediate image plane comprises at least two elongate illumination regions between which a central elongate region with a local minimum illumination intensity is situated.

7. The microscope as claimed in claim 6,
wherein
the two elongate illumination regions are symmetrical with respect to each other in relation to a mirror axis that extends through the central elongate region with a local minimum illumination intensity.

8. The microscope as claimed in claim 1,
wherein
a spatial light modulator for modulating the excitation light in the back focal plane of the microscope objective is arranged in the illumination beam path in an intermediate image plane and/or
a spatial light modulator for modulating the excitation light in a sample plane of the microscope objective is arranged in the illumination beam path in a pupil plane.

9. (canceled)

10. The microscope as claimed in claim 1,
wherein
the control unit is configured to set a slot width of the camera on the basis of a set microscope objective, on the basis of a respective set illumination pattern and/or on the basis of a utilized phase plate.

11. The microscope as claimed in claim 1,
wherein
a slot width of the camera is smaller than a lateral spacing of the intensity maxima of the two elongate regions in the second illumination pattern on the sensor surface perpendicular to a direction of the elongation.

12. The microscope as claimed in claim 1,
wherein
for the purpose of varying an axial pose of a plane in the sample optically conjugate to a sensor surface of the camera, the detection beam path comprises a controllable optics unit with variable refractive power.

13. The microscope as claimed in claim 12,
wherein
the controllable optics unit with variable refractive power is arranged in a pupil plane or in the vicinity of a pupil plane.

14. The microscope as claimed in claim 12,
wherein
the controllable optics unit with variable refractive power comprises one or more of the following components or is formed by one or more of the following components: controllable gravity-compensated liquid lens, controllable deformable mirror, electronically tunable lens, adaptive lens, spatial light modulator.

15. The microscope as claimed in claim 1,
wherein
the detection beam path comprises an image splitter unit of the type described in DE102021134427A1,
the detection beam path comprises a detection unit of the type described in DE102023100926.5, and/or
the detection beam path comprises a secondary color splitter of the type described in DE102023005252.3.

16. The microscope as claimed in claim 1,
wherein
the illumination beam path and the detection beam path comprise a common tube lens and wherein the excitation light and the emission light traverse the same intermediate image plane.

17. The microscope as claimed in claim 1,
wherein
the phase plate, the polarization manipulator, the cylindrical optics unit, the scanning unit, a main beam splitter, a scanning optics unit and the camera are arranged in an illumination/detection module which is coupled to a camera port of a microscope stand, wherein the microscope stand comprises the microscope objective and a tube lens.

18. The microscope as claimed in claim 1,
wherein
the control unit is configured to control the light source, the scanning unit, the camera and the polarization manipulator in a manner synchronized with one another.

19. The microscope as claimed in claim 1,
wherein
the control unit is configured to record an image of the sample using the first illumination pattern, subsequently record an image of the sample using the second illumination pattern and
finally calculate a difference between image data obtained using the first illumination pattern and the image data obtained using the second illumination pattern.

20. The microscope as claimed in claim 1,
wherein
the control unit is configured to switch back and forth between the first illumination pattern and the second illumination pattern in such a way that images of first line-shaped regions of the sample are recorded using the first illumination pattern, and subsequently an image of a second line-shaped region that at least partially overlaps with the respective first line-shaped region is recorded using the second illumination pattern.

21. The microscope as claimed in claim 1,
wherein
the detection beam path comprises a detection scanning unit that is arranged in a pupil plane or in the vicinity of a pupil plane and synchronized with the scanning unit and the camera.

22. The microscope as claimed in claim 21,
wherein
an enlargement of the detection beam path provided by the detection scanning unit is sufficiently large so that measurement data from camera pixels in a direction transverse to the direction of extent of the linear distribution of the emission light are evaluable using image scanning methods.

23. The microscope as claimed in claim 1,
wherein
the scanning unit is a two-dimensional scanning unit configured to scan an elongate illumination pattern back and forth in the direction of its elongation.

24. The microscope as claimed in claim 1,
wherein
the control unit is configured to operate a detection scanning unit or the detection scanning unit in the detection beam path in a manner synchronized with the scanning unit and the camera.

25. The microscope as claimed in claim 24,
wherein
the control unit is configured to operate the detection scanning unit at the same speed and with the same phase angle as the scanning unit.

26. (canceled)

27. A slide reader having a microscope as claimed in claim 1.

28. A microscopy method, wherein the following method steps are performed:
illuminating a sample region using excitation light,
setting a polarization state of the excitation light,
creating an illumination pattern that depends on the polarization state of the excitation light,
creating an elongate distribution of the excitation light,
the elongate distribution of the excitation light is guided via an illumination objective into the sample region and scanned through the sample region,
guiding emission light radiated by a sample in the sample region to a camera using a microscope objective and recording images of the sample the camera,
wherein
the emission light is guided onto the camera in non-descanned fashion and
a location of a slot-shaped readout region in a sensor plane of the camera is synchronized with a location of the elongate distribution of the excitation light in a plane of the sample.
